(19) United States
(12) Patent Application Publication
(10) Pub. No.: US 2020/0175627 A1
(43) Pub. Date: Jun. 4, 2020

(54) System and Methods for Facilitating Settlement Between Disputing Parties

(71) Applicant: One Day Decisions, LLC, Encino, CA (US)

(72) Inventors: Robert Steven Frankel, Encino, CA (US); Philip Nelson Tilden, JR., Highland, CA (US)

(73) Assignee: One Day Decisions, LLC, Encino, CA (US)

(21) Appl. No.: 16/780,043

(22) Filed: Feb. 3, 2020

Related U.S. Application Data
(63) Continuation of application No. 15/649,481, filed on Jul. 13, 2017.
Application No. 15/649,481 is a continuation-in-part of application No. 14/319,064, filed on Jun. 30, 2014, now abandoned.

(51) Int. Cl. G06Q 50/18; G06Q 10/10; G06Q 30/06; G06Q 20/40; G06Q 40/02

(52) U.S. Cl. CPC G06Q 50/188; G06Q 10/10; G06Q 40/02; G06Q 20/405; G06Q 50/182; G06Q 30/0601

(57) ABSTRACT

Methods and systems are provided for use in the settlement process for providing settlement terms between opposing parties. In at least one embodiment, the system receives dispute amounts and best offer amounts from each party. In order to proceed with the settlement process, the difference between the dispute amounts from each party is compared to and must be less than a maximum allowable dispute amount difference. Further, in at least one embodiment, the system determines a suggested settlement amount, in part, using data from each party's confidential best offer. The present system and method provide a safe and non-threatening approach to the settlement process, which promotes compromise and settlement. Moreover, the present system and method provide a simplified procedure for collecting the debt once settlement occurs.

### RELATED APPLICATIONS

This is a continuation application and so claims the benefit pursuant to 35 U.S.C. § 120 of a prior filed and co-pending U.S. non-provisional patent application serial number 15/649,481, filed on Jul. 13, 2017, which itself is a continuation-in-part application of U.S. non-provisional patent application Ser. No. 14/319,064, filed on Jun. 30, 2014. The contents of the aforementioned applications are incorporated herein by reference.

### BACKGROUND

The subject of this patent application relates generally to settlement negotiation, and more particularly to a system and method for facilitating settlement between disputing parties.

Applicant hereby incorporates herein by reference any and all patents and published patent applications cited or referred to in this application.

In disputes involving money, a plaintiff or creditor often attempts recovery from a defendant or debtor through the court system or collection services, either immediately or when attempts to directly collect the debt have failed. Some attempt to resolve the dispute through arbitration and mediation services. However, courts are often shorthanded and have increasing caseloads; and arbitration and mediation services may be too costly for small claims. Further, in arbitration and mediation, the process may become bogged down with argument and emotion. In court, judges may send the plaintiff and defendant out of the courtroom to negotiate or mediate face-to-face, in hopes that the case will settle before the hearing. Face-to-face negotiation, however, generally fails. Most people are inexperienced and intimidated with the negotiation and settlement process, which requires dispassionate problem-solving discussions on how best to find middle ground. Instead of settlement, the discussion often degrades into argument, resulting in both parties becoming more deeply entrenched and less likely to settle. After failure of the negotiation, the parties will present their cases before the judge.

The plaintiff has little control over the amount of the monetary judgment, which may full, significantly discounted, or completely denied. Moreover, the resulting monetary judgment against the defendant must thereafter be collected by the plaintiff. If the defendant refuses to pay, the plaintiff may never recover or may sell the debt to a collector at a significant loss. The defendant may not have the ability to pay the full judgment in one lump sum, as is customarily required, for example, by cash or check. Additionally, the defendant may feel that the process was unfair and one-sided, and may decide not to pay out of frustration. As a result, the plaintiff may see little or no money, and the defendant's credit score will suffer as a result of the judgment. In many cases, both parties end up feeling dissatisfied with the current process.

Aspects of the present invention fulfill these needs and provide further related advantages as described in the following summary.

### SUMMARY

Aspects of the present invention teach certain benefits in construction and use which give rise to the exemplary advantages described below.

The present invention solves the problems described above by providing a method and system for facilitating a monetary settlement process through automated settlement of a dispute, where the dispute may be between an initiating party utilizing an initiating computing device and an invited party utilizing an invited computing device over the internet. In at least one embodiment, under control of one or more computing systems configured with executable instructions, the method includes the action of: receiving a first offer amount and a first offer amount entered by the initiating party on the initiating computing device; receiving a second offer amount and a second offer amount entered by the invited party on the invited computing device; comparing the first offer amount to the second offer amount to determine a dispute amount difference; determining a suggested settlement amount utilizing a data set, where the data set contains at least one of the first offer amount and the second offer amount; and causing the suggested settlement amount to be displayed to both parties on the initiating computing device and the invited computing device, when securely logged on to the present web site.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 illustrates an example network, with a server having programs encoded on computer storage devices and configured to perform the actions of the methods, and two client computers connected to the server or other computing means through the Internet, in accordance with at least one embodiment;

FIG. 2 depicts a flow diagram that may be performed by a server or other computing means, in accordance with at least one embodiment;

FIG. 3 depicts a flow diagram that may be performed by a server or other computing means in the initial vetting stages of the settlement process, where an invitation is communicated and dispute amounts are compared, in accordance with at least one embodiment;

FIG. 4 depicts a flow diagram that may be performed by a server or other computing means in payment of the settlement service fee, in accordance with at least one embodiment;

FIG. 5 depicts a flow diagram that may be performed by a server or other computing means in order to generate a settlement amount, in accordance with at least one embodiment; and

FIG. 6 depicts a further flow diagram that may be performed by a server or other computing means in order to generate a settlement amount, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

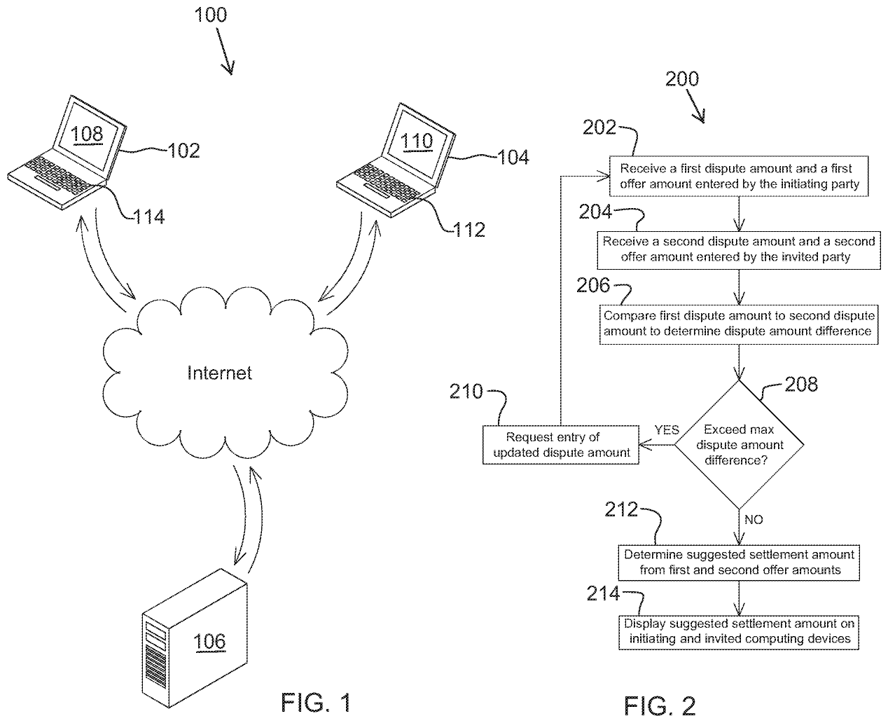

FIG. 1 illustrates an example of a computer network 100 with client computers (initiating computing device 102, and invited computing device 104) and a server 106 on which any of the methods and systems of various embodiments may be implemented. In particular the computer system, or server 106 in this example, may represent any of the computer systems and physical components necessary to perform the computerized methods discussed in connection with FIGS. 2-6 and, in particular, may represent a server (cloud, array, etc.), client, or other computer system upon which e-commerce servers, websites, web browsers and/or web analytic applications may be instantiated.

The illustrated exemplary server 106 is known to a person of ordinary skill in the art, and may include a processor, a bus for communicating information, a main memory coupled to the bus for storing information and instructions to be executed by the processor and for storing temporary variables or other intermediate information during the execution of instructions by processor, a static storage device or other non-transitory computer readable medium for storing static information and instructions for the processor, and a storage device, such as a hard disk, may also be provided and coupled to the bus for storing information and instructions. The server 106 may optionally be coupled to a display for displaying information. However, in the case of servers, such a display may not be present and all administration of the server 106 may be via remote clients. Further, the server 106 may optionally include an input device for communicating information and command selections to the processor, such as a keyboard, mouse, touchpad, and the like.

The server 106 may also include a communication interface coupled to the bus, for providing two-way, wired and/or wireless data communication to and from the server 106. For example, the communications interface may send and receive signals via a local area network or other network, including the Internet.

In the present illustrated example, in at least on embodiment, the hard drive of the server 106 is encoded with executable instructions, that when executed by a processor cause the processor to perform acts as described in the methods of FIGS. 2-6. The server 106 communicates through the Internet with one or both of the initiating computing device 102 and the invited computing device 104 to cause information and/or graphics to be displayed on the screens 108 and 110. An initiating party may enter information for communication to the server 106 through the keyboard 114. Likewise, an invited party may enter information for communication to the server 106 through the keyboard 112. Information transmitted to the server 106 by either the initiating computing device 102 or the invited computing device 104 may be stored on the server 106 for use in calculations, creation of documents, charging fees, initiating further communications, or for other purposes.

FIG. 2 is a flow diagram of an exemplary method (200) for conducting a settlement process between a initiating party and an invited party, which may be performed on the server 106. In the exemplary method (200), the initiating party input is received, where the input is a first offer amount (202). Similarly, the invited party input is received, where the input is a second offer amount (204). The first offer amount is the monetary amount in controversy from the initiating party's perspective. Likewise, the second offer amount is the monetary amount in controversy from the invited party's perspective. In other words, the first offer amount represents the approximate amount the initiating party believes is owed, either to or from the initiating party; and the second offer amount represents the approximate amount the invited party believes is owed, either to or from the invited party. Thus, where the initiating party is the creditor (i.e., the party to whom money is owed), the first offer amount represents the minimum value the initiating party is willing to accept to resolve the matter; and where the initiating party is the debtor (i.e., the party from whom money is owed), the first offer amount represents the maximum value the initiating party is willing to pay to resolve the matter. Similarly, where the invited party is the creditor, the second offer amount represents the minimum value the invited party is willing to accept to resolve the matter; and where the invited party is the debtor, the second offer amount represents the maximum value the invited party is willing to pay to resolve the matter. For simplicity purposes, the offer amount provided by the creditor is referred to herein as the “creditor offer,” while the offer amount provided by the debtor is referred to herein as the “debtor offer.” In at least one embodiment, a third input is received, representing a value of the matter that has been agreed upon by the initiating party and the invited party.

In at least one embodiment, the server 106 compares the first offer amount, second offer amount and matter value against a probability table to determine the probability of the initiating and invited parties being able to settle the matter. For example if the matter value is in a range of $200 to $500, the probability table may indicate that the maximum value a debtor will pay must be greater than 80% of the matter value, and the minimum value the creditor will accept must be less than 90% of the matter value. As another example, if the matter value is in a range of $5,000 to $10,000, the probability table may indicate that the maximum value a debtor will pay must be greater than 75% of the matter value, and the minimum value the creditor will accept must be less than 87% of the matter value. It should be noted that while the term “table” is used herein to describe certain exemplary data structures, in at least one embodiment, any other suitable data type or data structure, or combinations thereof, now known or later developed, capable of storing the appropriate data, may be substituted. Thus, the present invention should not be read as being so limited.

With continued referenced to FIG. 2, in at least one embodiment, the first offer amount is compared to the second offer amount to determine a dispute amount difference (206). The dispute amount difference may be calculated, for example, by taking the absolute value of difference of the first offer amount and the second offer amount, which may be represented numerically or as a percentage difference. In a preferred embodiment, the dispute amount difference is represented as a percentage difference, which is then compared to a maximum allowable dispute amount difference to determine if the dispute amount difference exceeds the maximum (208).

When the dispute amount difference exceeds the maximum, an updated dispute amount prompt is communicated to and caused to display on one or both of the initiating 102 and the invited 104 computing devices (210). The purpose of this step is to further gauge the probability of a successful settlement. If the dispute amounts entered by each party are wildly different, there is little probability that the parties will agree to a suggested settlement, and prevents wasted time and frustration for both parties. The maximum dispute amount may vary according to correlations found in prior settlement amounts. For example, it may be found that if a dispute amount difference exceeds 10%, the chance of successful settlement drastically decreases. Thus, the maximum dispute amount difference may be set at 10%. In another example, the maximum dispute amount difference may require that the first and second offer amounts be within an order of magnitude of one another. Yet other example maximum dispute amount differences may be 20%, 30%, 40%, 50%, 60%, 70%, 80%, and 90% difference. The first offer amount, the second offer amount, and the dispute amount difference may be displayed on either or both of the initiating 102 and the invited 104 computing devices, so that both parties know the differences in the dispute amounts. Alternately, if the dispute amount difference exceeds the maximum dispute amount difference, the parties may simply be informed that they are too far apart and should adjust their respective positions, without displaying the dispute amount difference.

If the dispute amount difference does not exceed the maximum dispute amount difference, then the present method determines a suggested settlement amount, at least in part calculated from a dataset containing the first offer amount and the second offer amount (212). As mentioned above, the first offer amount entered at step (202) represents an initial best offer from the initiating party, or an initial monetary amount that would cause the initiating party to settle, if accepted by the invited party. Similarly, the second offer amount entered at step (204) represents an initial best offer from the invited party, or an initial monetary amount that would cause the invited party to settle, if accepted by the initiating party. As will be further described below, each party may enter updated offer amounts, as prompted by the system. Generally, the first and second offer amounts are kept in confidence, so that the first offer amount is not communicated to the invited computing device 104, and the second offer amount is not communicated to the initiating computing device 102.

In at least one embodiment, once a suggested settlement amount has been determined (212), both parties are notified to securely log on to the server where the suggested settlement amount is communicated to and is caused to display on the initiating computing device 102 and the invited computing device 104.

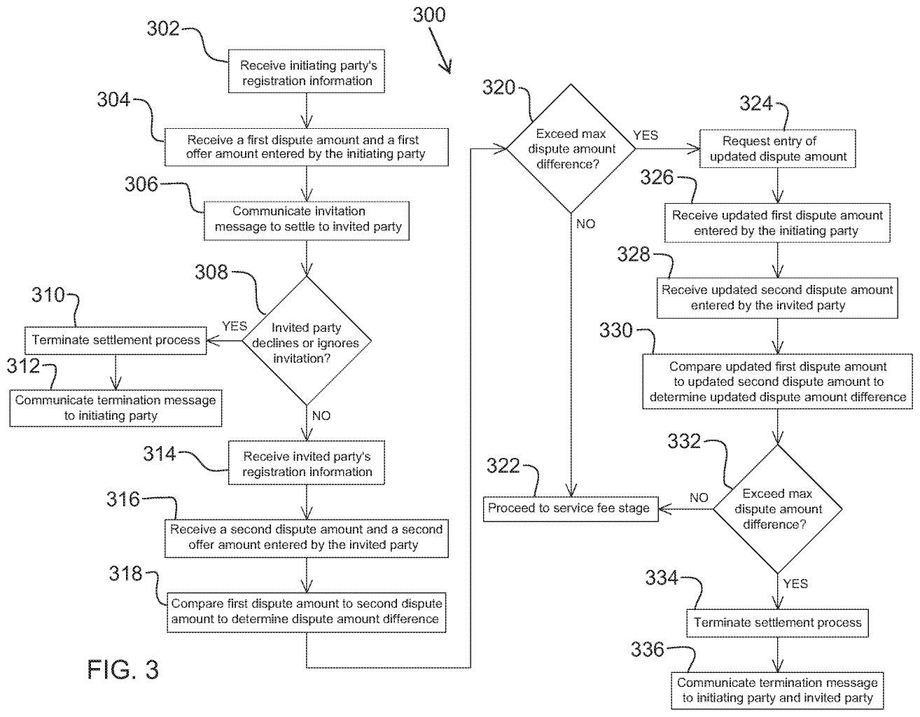

Another embodiment of the present system and method is illustrated in FIG. 3, which a flow diagram of an exemplary method (300) for an initiating party to invite an invited party to participate in the settlement process, including at least some steps as disclosed in FIG. 2. The initiating party enters his, hers, or its (in the case of a corporation, etc.) registration information (302), which may include the name, account name, contact information, the first case description summary, evidence (such as receipts, contracts, photos or other pertinent document), and the invited party's contact information (such as an email address), which is received by the server 106. Then, the first offer amount is received (304). The initiating party enters a first case description summary; and invited party may accept the summary or enter a second case description summary.

An invitation message is communicated to the invited party (304). In one example, an email message is sent containing the invitation to participate in the settlement process and a link to the settlement website. The settlement website is preferably a confidential portal through which the settlement information is communicated to the one or both of the initiating 102 and invited 104 computing devices. For example, the initiating computing device 102 may display a confidential initiating party portal through an initiating graphical user interface, and the invited computing device 104 may display a confidential invited party portal an invited graphical user interface, through which confidential and shared information may be sent or received.

If the invited party ignores the invitation message or actively declines the invitation (308), then the settlement process is terminated (310), and a termination message is sent to the initiating party (312), by email, through the confidential initiating party portal, by cellular phone text message, or other communication means.

If the invited party accepts the invitation, then the invited party enters his, hers, or its registration information (314), which may include the name, account name, contact information, the second case description summary, and evidence (such as receipts, contracts, or other pertinent document), which is received by the server 106. Then, the second offer amount is received (316).

The first offer amount is compared to the second offer amount to determine a dispute amount difference (318), as described in reference to FIG. 2, step (206). The dispute amount difference is compared to a maximum allowable dispute amount difference to determine if the dispute amount difference exceeds the maximum (320). If the dispute amount difference exceeds the maximum, an updated dispute amount prompt is communicated to and caused to display on one or both of the initiating 102 and the invited 104 computing devices (324).

The updated first offer amount is received (326), if entered by the initiating party on the initiating computing device 102. And, the updated second offer amount is received (328), if entered by the invited party on the invited computing device 104. The updated first offer amount is compared to the updated second offer amount to determine an updated dispute amount difference (330).

The updated dispute amount difference is compared to the maximum allowable dispute amount difference to determine if the updated dispute amount difference exceeds the maximum (332). If the dispute amount difference exceeds the maximum, the settlement process is terminated (334), and a termination message is sent to the initiating 102 and invited 104 computing devices (336). As an option, a renewed updated dispute amount prompt may be communicated to and caused to display on one or both of the initiating 102 and the invited 104 computing devices, permitting the entry of yet another dispute amount by one or both parties. Thus, in this optional example, each party is permitted three entries of dispute amounts before termination of the process.

When the dispute amount difference does not exceed the maximum dispute amount difference (320) or when the updated dispute amount difference does not exceed the maximum dispute amount difference (332), the process is advanced to the service fee stage (322).

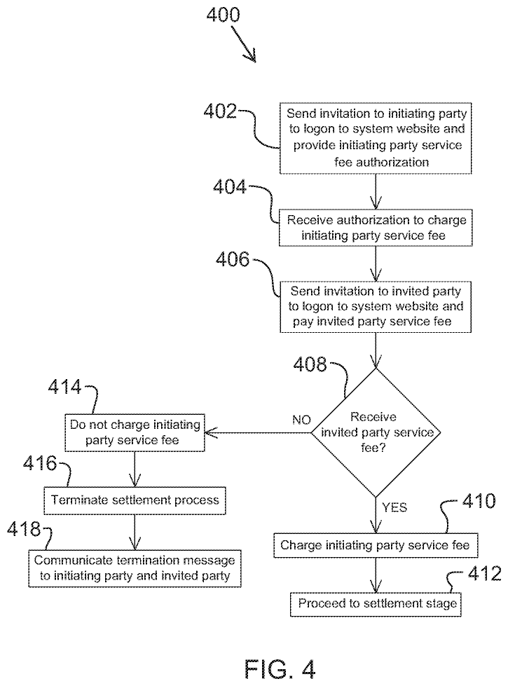

FIG. 4 discloses a flow diagram of an exemplary method (400) for charging a service fee to both parties. Prepayment of a service fee may cause the initiating party to hesitate, as the initiating party may be unsure of the invited party's good faith and willingness to engage in the settlement process. Thus, the present process (400) allows for the authorization to charge a service fee to the initiating party, without charging the fee until the service fee is collected from the invited party. After the initiating party has registered (302), the system sends a communication or invitation requesting the initiating party provide authorization to be charged a initiating party service fee (such as providing a credit card or bank account routing number) (402). The initiating party may be required to log on to the service by entering a user name and password. When the authorization to charge the service fee to the initiating party is received (406), an invitation is sent to the invited party to create an account or log on to a created account, so that a invited party service fee may be charged (406).

If the invited party service fee is received (408), then the initiating party service fee is actually charged (410) and the process is advanced to the settlement process stage (412). In this way, the initiating party is not charged until the invited party agrees to pay or actually pays the invited party service fee. Both parties paying the service fee generally indicates that the settlement process will likely be taken seriously and in good faith.

If, however, the invited party service fee is not received or not charged (414), then the settlement process is terminated (416), and a termination message is sent to the initiating party and invited party (418), by email, through the confidential initiating party portal, by cellular phone text message, or other communication means.

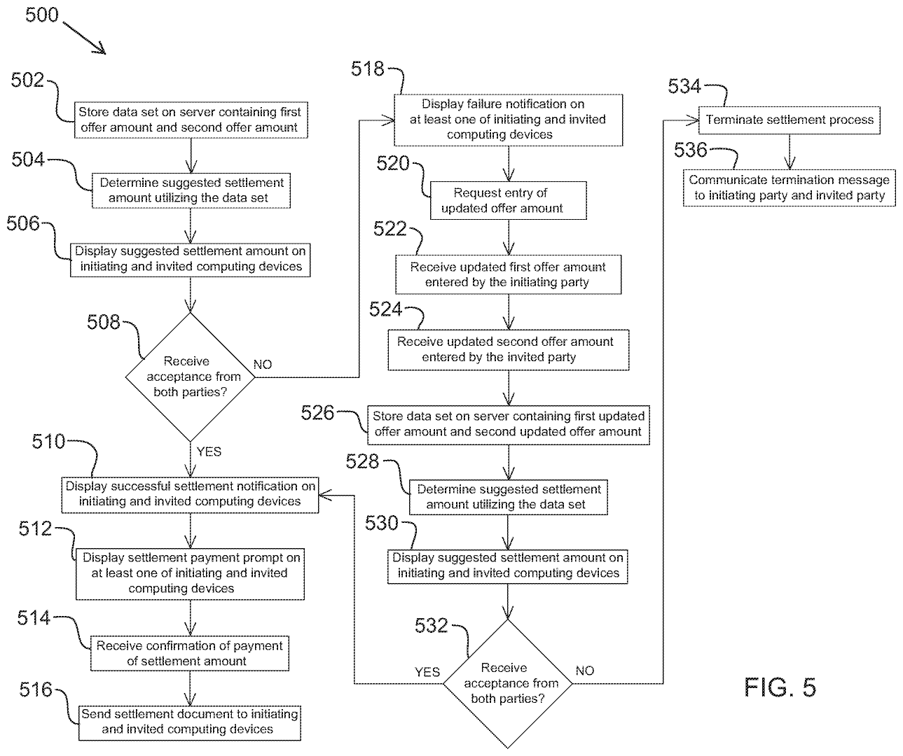

FIG. 5 depicts a flow diagram of an exemplary method (500) for determining settlement amount to facilitate a settlement between the parties. After both parties enter respective dispute amounts and offer amounts and the system has determined that the dispute amount difference or updated dispute amount difference does not exceed the maximum dispute amount difference (as described in FIG. 3), a data set containing the first offer amount and the second offer amount is stored in memory on the server 106 (502). The data set may optionally further contain at least one of the first offer amount, the second offer amount, the updated first offer amount, and the updated second offer amount. A suggested settlement amount is calculated or otherwise determined utilizing the quantities in the dataset (504). The suggested settlement amount may be a quantity between the first offer amount and the second offer amount.

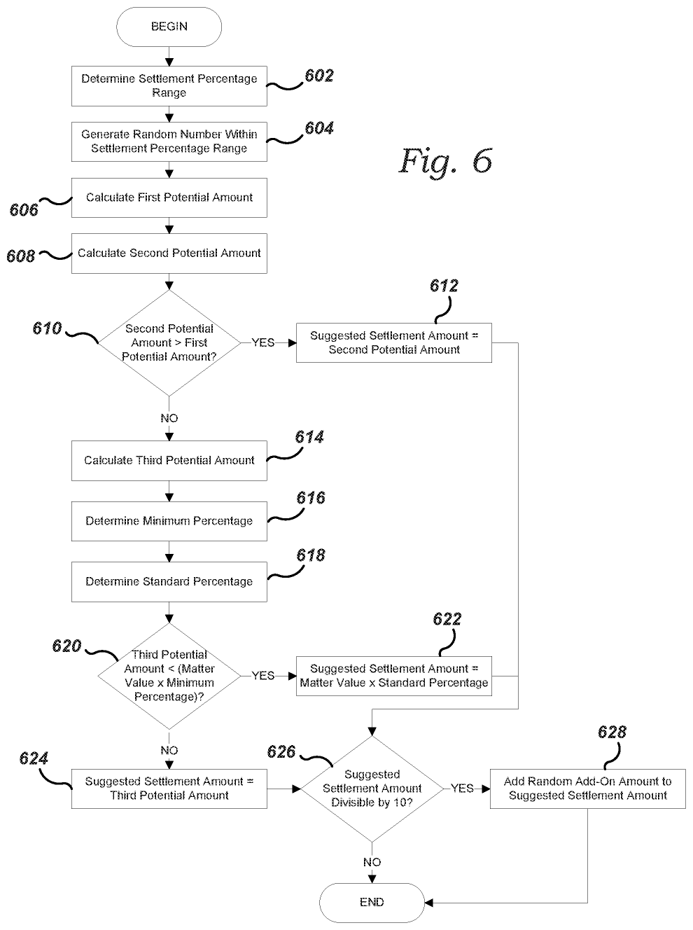

In at least one embodiment, as illustrated in the flow diagram of FIG. 6, the method of determining the suggested settlement amount begins with determining a settlement percentage range based on the matter value (602), which is subsequently used to determine a suggested settlement amount having a relatively high probability of being accepted by both the initiating party and the invited party, as discussed further below. For example, in at least one such embodiment, relatively lower matter values may have a settlement percentage range between 83% and 92%, while relatively higher matter values may have a settlement percentage range between 70% and 86%. In at least one embodiment, the server 106 maintains a range table containing a lower end value (representing the lower end of the settlement percentage range) and an upper end value (representing the upper end of the settlement percentage range) for each matter value—or alternatively, for each range of matter values. Thus, in such an embodiment, the settlement percentage range is determined based on the values contained in the range table that correspond to the matter value. After determining the settlement percentage range, the server 106 generates a random number that falls within the settlement percentage range, the random number representing a settlement percentage (604). In at least one embodiment, the server 106 calculates a first potential amount by multiplying the matter value by the settlement percentage (606).

With continued reference to FIG. 6, in at least one embodiment, the server 106 calculates a second potential amount based on the creditor offer and the debtor offer (608). Specifically, in at least one such embodiment, if the debtor offer (i.e., the maximum value the debtor is willing to pay to resolve the matter) is less than the creditor offer (i.e., the minimum value the creditor is willing to accept to resolve the matter), then the second potential amount is set to be equal to the debtor offer. Otherwise, if the debtor offer is greater than or equal to the creditor offer, the second potential amount is set to be equal to the creditor offer. In at least one embodiment, upon determining that the second potential amount is greater than the first potential amount (610), the suggested settlement amount is set to be equal to the second potential amount (612).

Otherwise, upon determining that the second potential amount is less than or equal to the first potential amount (610), the server 106 calculates a third potential amount (614); the third potential amount being equal to the difference between the creditor offer and the debtor offer, multiplied by the settlement percentage, plus the second potential amount—i.e., third potential amount=((creditor offer−debtor offer)×settlement percentage)+second potential amount. In at least one embodiment, the server 106 also determines a minimum percentage based on at least one of the matter value, the creditor offer and the debtor offer (616). In at least one such embodiment, the server 106 maintains a percentage table containing such a minimum percentage value for each of at least one of the matter value, creditor offer the debtor offer—or alternatively, for given ranges of said values/amounts. In at least one embodiment, the server 106 also determines a standard percentage based on at least one of the matter value, the creditor offer and the debtor offer (618). In at least one such embodiment, the percentage table contains such a standard percentage value for each of at least one of the matter value, creditor offer the debtor offer—or alternatively, for given ranges of said values/amounts. In at least one embodiment, upon determining that the third potential amount is less than the product of the matter value and the minimum percentage (620), the suggested settlement amount is set to be equal to the product of the matter value and the standard percentage (622). Otherwise, upon determining that the third potential amount is greater than or equal to the product of the matter value and the minimum percentage (620), the suggested settlement amount is set to be equal to the third potential amount (624).

With continued reference to FIG. 6, in at least one embodiment, upon determining that the suggested settlement amount is divisible by ten (i.e., the suggested settlement amount ends in “0.00”) (626), the server 106 generates a random add-on amount to be added to the suggested settlement amount (628). In at least one such embodiment, the add-on amount is a randomly generated number that falls between a pre-defined upper add-on limit and a pre-defined lower add-on limit. It should be noted that, in at least one further embodiment, the method of determining the suggested settlement amount may incorporate other steps and/or calculations, now known or later developed.

Referring again to FIG. 5, in at least one embodiment, the suggested settlement amount is communicated to and caused to display on the initiating computing device 102 and the invited computing device 104 (506), preferably through a confidential secured portal. Due to the confidential nature of the settlement process, an notification may be sent to the email addresses associated with each party. The email notifies the party of an occurrence, and prompts the party to logon to the party's account to view the message. For example, when the suggested settlement amount is determined, an email notification of this event is sent to the initiating party and the invited party. In order to view the settlement amount, the parties must logon to the website or application portal.

The parties are given the option to accept or decline the suggested settlement amount (508). If a decline message is received from one or both parties, then a failure notification is caused to display on one or both of the initiating computing device 102 and the invited computing device 104 (518). The initiating party may be given an opportunity to enter an updated first offer amount, and the invited party may be given an opportunity to enter an updated second offer amount. The updated offer amounts from each party may be the same or different from the offer amount originally entered. The updated first offer amount is received (522). And, the updated second offer amount is received (524). In at least one embodiment, the process may be optionally terminated if either one or both of the updated offer amounts are not received. In at least one embodiment, an updated suggested settlement amount is then determined (528) by performing steps (602) through (628) again, based on the updated first offer amount and updated second offer amount. The updated suggested settlement is communicated to each party and the updated amount is caused to display on the initiating computing device 102 and the invited computing device 104 (530), preferably through a confidential secured portal.

The parties are once again given the option to accept or decline the suggested settlement amount (532). If a decline message is received from one or both parties, then a failure notification is caused to display on one or both of the initiating computing device 102 and the invited computing device 104 (518), and the settlement process may be terminated (536). As an option, the parties may be given yet another opportunity to enter a renewed updated offer amount, permitting a third round of attempted settlement. This process may repeat a pre-determined number of times, as defined by the server 106 or the parties.

If an indication of acceptance is received from both the initiating computing device 102 and the invited computing device 104, then a successful settlement notification is caused to display on the initiating computing device 102 and the invited computing device 104 (510).

Depending on whether the initiating party or invited party is the debtor, a settlement payment prompt is caused to display on one of the initiating computing device 102 and the invited computing device 104 (512). The debt owed by the debtor would be equivalent to the suggested settlement amount or the updated suggested settlement amount. For example, if the invited party is the debtor, the settlement payment prompt is caused to display on the invited computing device 104. In this case, the invited party would enter payment information, such as a credit card number or bank account routing number, for payment of the agreed debt. The present system or a third party system may process or facilitate the payment of the debt to the creditor, the initiating party in this example. Payment may involve transfer of funds from the debtor's payment source to the creditor's bank account or other indicated account.

After payment of the suggested settlement amount by the debtor, confirmation of the payment is received. A payment confirmation message may be sent to the creditor's computing device 102 or 104. Further, a settlement document may be communicated to the initiating computing device 102 and the invited computing device 104, describing the settlement terms and other pertinent information.

Aspects of the present specification may also be described as follows:

1. A method for automatically facilitating a monetary settlement process in connection with a dispute between an initiating party utilizing an initiating computing device and an invited party utilizing an invited computing device, the method comprising the steps of: implementing an at least one server in selective communication with each of the initiating computing device and invited computing device; receiving, via the at least one server, a creditor offer representing the minimum value the appropriate one of the initiating party and invited party is willing to accept to resolve the matter; receiving, via the at least one server, a debtor offer representing the maximum value the appropriate one of the initiating party and invited party is willing to pay to resolve the matter; receiving, via the at least one server, a matter value from at least one of the initiating computing device and the invited computing device; comparing, via the at least one server, the creditor offer and the debtor offer to determine a dispute amount difference; determining, via the at least one server, a settlement percentage; calculating, via the at least one server, a first potential amount by multiplying the matter value by the settlement percentage; calculating, via the at least one server, a second potential amount based on the creditor offer and the debtor offer; upon the at least one server determining that the second potential amount is greater than the first potential amount, setting the settlement amount to be equal to the second potential amount; upon the at least one server determining that the second potential amount is less than or equal to the first potential amount, calculating, via the at least one server, a third potential amount; determining, via the at least one server, a minimum percentage based on at least one of the matter value, the creditor offer and the debtor offer; determining, via the at least one server, a standard percentage based on at least one of the matter value, the creditor offer and the debtor offer; upon the at least one server determining that the third potential amount is less than the product of the matter value and the minimum percentage, setting the suggested settlement amount to be equal to the product of the matter value and the standard percentage; upon the at least one server determining that the third potential amount is greater than or equal to the product of the matter value and the minimum percentage, setting the suggested settlement amount to be equal to the third potential amount; and causing the suggested settlement amount to be displayed on the initiating computing device and the invited computing device.

2. The method according to embodiment 1, wherein the step of determining a settlement percentage further comprises the steps of: determining a settlement percentage range based on the matter value; and generating a random number that falls within the settlement percentage range, the random number representing a settlement percentage.

3. The method according to embodiments 1-2, wherein the step of calculating a second potential amount further comprises the steps of: upon determining that the debtor offer is less than the creditor offer, setting the second potential amount to be equal to the debtor offer; and upon determining that the debtor offer is greater than or equal to the creditor offer, setting the second potential amount to be equal to the creditor offer.

4. The method according to embodiments 1-3, wherein the step of calculating a third potential amount further comprises the steps of: setting the third potential amount to be equal to the difference between the creditor offer and the debtor offer, multiplied by the settlement percentage, plus the second potential amount.

5. The method according to embodiments 1-4, further comprising the step of, upon the at least one server determining that the suggested settlement amount is divisible by ten, generating a random add-on amount to be added to the suggested settlement amount.

6. The method according to embodiments 1-5, wherein the step of generating a random add-on amount further comprises the step of generating a random number that falls between a pre-defined upper add-on limit and a pre-defined lower add-on limit.

7. The method according to embodiments 1-6, further comprising the steps of:

comparing the dispute amount difference with a maximum dispute amount difference; and when the dispute amount difference exceeds the maximum dispute amount difference, causing a dispute update prompt to be displayed on at least one of the initiating computing device and the invited computing device, the dispute update prompt requesting entry of an updated dispute amount.

8. The method according to embodiments 1-7, further comprising the steps of, when the dispute amount difference exceeds the maximum dispute amount difference: causing a first offer update prompt to be displayed on the appropriate one of the initiating computing device and invited computing device, the first offer update prompt requesting entry of an updated creditor offer; causing a second offer update prompt to be displayed on the appropriate one of the initiating computing device and invited computing device, the second offer update prompt requesting entry of an updated debtor offer; receiving the updated creditor offer and debtor offer; and comparing the updated creditor offer to the updated debtor offer to determine an updated dispute amount difference.

9. The method according to embodiments 1-8, further comprising the step of terminating the monetary settlement process if at least one of the updated creditor offer and the updated debtor offer are not received.

10. The method according to embodiments 1-9, further comprising the steps of: causing an invitation message to be displayed on the invited computing device, the invitation message communicating a request to the invited party to participate in the monetary settlement process; and causing an initial prompt to be displayed on the invited computing device, the initial prompt requesting entry of the appropriate one of the creditor offer and the debtor offer.

11. The method according to embodiments 1-10, further comprising the step of terminating the monetary settlement process if the appropriate one of the creditor offer and the debtor offer is not received.

12. The method according to embodiments 1-11, further comprising the steps of: receiving an initiating party authorization from the initiating computing device, the initiating authorization granting permission from the initiating party to authorize an initiating party service fee prior to the step of causing an invitation message to be displayed on the invited computing device; causing an invited party service fee to be displayed on the invited computing device; and when an invited party authorization is received, charging the initiating party service fee and charging the invited party service fee, the invited party authorization granting permission of the invited party to charge the invited party service fee.

13. The method according to embodiments 1-12, wherein the initiating computing device is capable of displaying an initiating graphical user interface and the invited computing device is capable of displaying an invited graphical user interface, and the step of causing the suggested settlement amount to be displayed further comprising: causing the suggested settlement amount and an initiating party settlement option to be displayed within the initiating graphical user interface, the initiating party settlement option permitting entry by the initiating party acceptance or rejection of the suggested settlement amount; and causing the suggested settlement amount and an invited party settlement option to be displayed within the invited graphical user interface, the invited party settlement option permitting entry by the invited party acceptance or rejection of the suggested settlement amount.

14. The method according to embodiments 1-13, further comprising the steps of: receiving an initiating party settlement decision; receiving an inviting party settlement decision; and causing a settlement outcome to be displayed on at least one of the initiating computing device and the invited computing device.

15. The method according to embodiments 1-14, further comprising the step of, when at least one of an initiating party settlement decision and the invited party settlement decision indicates rejection of the suggested settlement amount, causing a failure notification to be displayed on at least one of the initiating computing device and the invited computing device.

16. The method according to embodiments 1-15, further comprising the step of causing an offer update prompt to be displayed on at least one of the initiating computing device and the invited computing device, the offer update prompt requesting entry of an updated appropriate one of the creditor offer and the debtor offer.

17. The method according to embodiments 1-16, further comprising the steps of: communicating a first offer update prompt to the initiating computing device requesting entry of an updated appropriate one of the creditor offer and the debtor offer; and communicating a second offer update prompt to the invited computing device requesting entry of an updated appropriate one of the creditor offer and the debtor offer.

18. The method according to embodiments 1-17, further comprising the steps of: receiving the updated creditor offer; receiving the updated debtor offer; determining an updated suggested settlement amount utilizing an updated data set containing at least one of the updated creditor offer and the updated debtor offer; and causing the updated suggested settlement amount to be displayed on the initiating computing device and the invited computing device.

19. The method according to embodiments 1-18, further comprising the steps of: receiving a first case description summary entered on the initiating computing device; and receiving a second case summary entered on the inviting computing device.

20. The method according to embodiments 1-19, further comprising the steps of, when the initiating party decision and the invited party decision both indicate an acceptance of the suggested settlement amount: causing a successful settlement notification to be displayed on the initiating computing device and the invited computing device; causing a settlement payment prompt to be displayed on one of the initiating computing device and the invited computing device, the settlement payment prompt requesting the payment of a debt amount indicated in the suggested settlement amount; receiving a debt payment confirmation; and communicating a settlement document to the initiating computing device and the invited computing device, the settlement document describing settlement terms of the dispute.

21. A method for automatically facilitating a monetary settlement process in connection with a dispute between an initiating party utilizing an initiating computing device and an invited party utilizing an invited computing device, the method comprising the steps of: implementing an at least one server in selective communication with each of the initiating computing device and invited computing device; receiving, via the at least one server, a creditor offer representing the minimum value the appropriate one of the initiating party and invited party is willing to accept to resolve the matter; receiving, via the at least one server, a debtor offer representing the maximum value the appropriate one of the initiating party and invited party is willing to pay to resolve the matter; receiving, via the at least one server, a matter value from at least one of the initiating computing device and the invited computing device; comparing, via the at least one server, the creditor offer and the debtor offer to determine a dispute amount difference; determining, via the at least one server, a settlement percentage; calculating, via the at least one server, a first potential amount by multiplying the matter value by the settlement percentage; calculating, via the at least one server, a second potential amount based on the creditor offer and the debtor offer; upon determining that the debtor offer is less than the creditor offer, setting a second potential amount to be equal to the debtor offer; upon determining that the debtor offer is greater than or equal to the creditor offer, setting the second potential amount to be equal to the creditor offer; upon the at least one server determining that the second potential amount is greater than the first potential amount, setting the settlement amount to be equal to the second potential amount; upon the at least one server determining that the second potential amount is less than or equal to the first potential amount, calculating, via the at least one server, a third potential amount, the third potential amount being equal to the difference between the creditor offer and the debtor offer, multiplied by the settlement percentage, plus the second potential amount; determining, via the at least one server, a minimum percentage based on at least one of the matter value, the creditor offer and the debtor offer; determining, via the at least one server, a standard percentage based on at least one of the matter value, the creditor offer and the debtor offer; upon the at least one server determining that the third potential amount is less than the product of the matter value and the minimum percentage, setting the suggested settlement amount to be equal to the product of the matter value and the standard percentage; upon the at least one server determining that the third potential amount is greater than or equal to the product of the matter value and the minimum percentage, setting the suggested settlement amount to be equal to the third potential amount; and causing the suggested settlement amount to be displayed on the initiating computing device and the invited computing device.

22. A system for facilitating a monetary settlement process in connection with a dispute between an initiating party and an invited party, the system comprising: an initiating computing device under the control of the initiating party; an invited computing device under the control of the invited party; and a central computer system in communication with each of the initiating computing device and invited computing device; wherein, upon the initiating party and invited party desiring to negotiate a monetary settlement of the dispute through the computer system, the computer system is configured for: receiving, via the at least one server, a creditor offer representing the minimum value the appropriate one of the initiating party and invited party is willing to accept to resolve the matter; receiving, via the at least one server, a debtor offer representing the maximum value the appropriate one of the initiating party and invited party is willing to pay to resolve the matter; receiving, via the at least one server, a matter value from at least one of the initiating computing device and the invited computing device; comparing, via the at least one server, the creditor offer and the debtor offer to determine a dispute amount difference; determining, via the at least one server, a settlement percentage; calculating, via the at least one server, a first potential amount by multiplying the matter value by the settlement percentage; calculating, via the at least one server, a second potential amount based on the creditor offer and the debtor offer; upon the at least one server determining that the second potential amount is greater than the first potential amount, setting the settlement amount to be equal to the second potential amount; upon the at least one server determining that the second potential amount is less than or equal to the first potential amount, calculating, via the at least one server, a third potential amount; determining, via the at least one server, a minimum percentage based on at least one of the matter value, the creditor offer and the debtor offer; determining, via the at least one server, a standard percentage based on at least one of the matter value, the creditor offer and the debtor offer; upon the at least one server determining that the third potential amount is less than the product of the matter value and the minimum percentage, setting the suggested settlement amount to be equal to the product of the matter value and the standard percentage; upon the at least one server determining that the third potential amount is greater than or equal to the product of the matter value and the minimum percentage, setting the suggested settlement amount to be equal to the third potential amount; and causing the suggested settlement amount to be displayed on the initiating computing device and the invited computing device.

In closing, regarding the exemplary embodiments of the present invention as shown and described herein, it will be appreciated that a system and method for facilitating settlement between disputing parties is disclosed. Because the principles of the invention may be practiced in a number of configurations beyond those shown and described, it is to be understood that the invention is not in any way limited by the exemplary embodiments, but is generally directed to a system and method for facilitating settlement between disputing parties and is able to take numerous forms to do so without departing from the spirit and scope of the invention. Furthermore, the various features of each of the above-described embodiments may be combined in any logical manner and are intended to be included within the scope of the present invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

Any claims intended to be treated under 35 U.S.C. § 112(f) will begin with the words “means for,” but use of the term “for” in any other context is not intended to invoke treatment under 35 U.S.C. § 112(f). Accordingly, Applicant reserves the right to pursue additional claims after filing this application, in either this application or in a continuing application.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment. Additionally, the various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The phrase “non-transitory ,” in addition to having its ordinary meaning, as used in this document means “enduring or long-lived”. The phrase “non-transitory computer readable medium,” in addition to having its ordinary meaning, includes any and all computer readable mediums, with the sole exception of a transitory, propagating signal. This includes, by way of example and not limitation, non-transitory computer-readable mediums such as register memory, processor cache and random-access memory (“RAM”).

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method for automatically facilitating a monetary settlement process in connection with a dispute between an initiating party utilizing an initiating computing device and an invited party utilizing an invited computing device, the method comprising the steps of:
implementing an at least one server in selective communication with each of the initiating computing device and invited computing device;
receiving, via the at least one server, a creditor offer representing the minimum value the appropriate one of the initiating party and invited party is willing to accept to resolve the matter;
receiving, via the at least one server, a debtor offer representing the maximum value the appropriate one of the initiating party and invited party is willing to pay to resolve the matter;
receiving, via the at least one server, a matter value from at least one of the initiating computing device and the invited computing device;
comparing, via the at least one server, the creditor offer and the debtor offer to determine a dispute amount difference;
determining, via the at least one server, a settlement percentage;
calculating, via the at least one server, a first potential amount by multiplying the matter value by the settlement percentage;
calculating, via the at least one server, a second potential amount based on the creditor offer and the debtor offer;
upon the at least one server determining that the second potential amount is greater than the first potential amount, setting the settlement amount to be equal to the second potential amount;
upon the at least one server determining that the second potential amount is less than or equal to the first potential amount, calculating, via the at least one server, a third potential amount;
determining, via the at least one server, a minimum percentage based on at least one of the matter value, the creditor offer and the debtor offer;
determining, via the at least one server, a standard percentage based on at least one of the matter value, the creditor offer and the debtor offer;
upon the at least one server determining that the third potential amount is less than the product of the matter value and the minimum percentage, setting the suggested settlement amount to be equal to the product of the matter value and the standard percentage;
upon the at least one server determining that the third potential amount is greater than or equal to the product of the matter value and the minimum percentage, setting the suggested settlement amount to be equal to the third potential amount; and
causing the suggested settlement amount to be displayed on the initiating computing device and the invited computing device.

2. The method of claim 1, wherein the step of determining a settlement percentage further comprises the steps of:
determining a settlement percentage range based on the matter value; and
generating a random number that falls within the settlement percentage range, the random number representing a settlement percentage.

3. The method of claim 1, wherein the step of calculating a second potential amount further comprises the steps of:
upon determining that the debtor offer is less than the creditor offer, setting the second potential amount to be equal to the debtor offer; and
upon determining that the debtor offer is greater than or equal to the creditor offer, setting the second potential amount to be equal to the creditor offer.

4. The method of claim 1, wherein the step of calculating a third potential amount further comprises the steps of:
setting the third potential amount to be equal to the difference between the creditor offer and the debtor offer, multiplied by the settlement percentage, plus the second potential amount.

5. The method of claim 1, further comprising the step of, upon the at least one server determining that the suggested settlement amount is divisible by ten, generating a random add-on amount to be added to the suggested settlement amount.

6. The method of claim 5, wherein the step of generating a random add-on amount further comprises the step of generating a random number that falls between a pre-defined upper add-on limit and a pre-defined lower add-on limit.

7. The method of claim 1, further comprising the steps of:
comparing the dispute amount difference with a maximum dispute amount difference; and
when the dispute amount difference exceeds the maximum dispute amount difference, causing a dispute update prompt to be displayed on at least one of the initiating computing device and the invited computing device, the dispute update prompt requesting entry of an updated dispute amount.

8. The method of claim 7, further comprising the steps of, when the dispute amount difference exceeds the maximum dispute amount difference:
causing a first offer update prompt to be displayed on the appropriate one of the initiating computing device and invited computing device, the first offer update prompt requesting entry of an updated creditor offer;
causing a second offer update prompt to be displayed on the appropriate one of the initiating computing device and invited computing device, the second offer update prompt requesting entry of an updated debtor offer;
receiving the updated creditor offer and debtor offer; and
comparing the updated creditor offer to the updated debtor offer to determine an updated dispute amount difference.

9. The method of claim 1, further comprising the steps of:
causing an invitation message to be displayed on the invited computing device, the invitation message communicating a request to the invited party to participate in the monetary settlement process; and
causing an initial prompt to be displayed on the invited computing device, the initial prompt requesting entry of the appropriate one of the creditor offer and the debtor offer.

10. The method of claim 9, further comprising the steps of:
receiving an initiating party authorization from the initiating computing device, the initiating authorization granting permission from the initiating party to authorize an initiating party service fee prior to the step of causing an invitation message to be displayed on the invited computing device;
causing an invited party service fee to be displayed on the invited computing device; and
when an invited party authorization is received, charging the initiating party service fee and charging the invited party service fee, the invited party authorization granting permission of the invited party to charge the invited party service fee.

11. The method of claim 1, wherein the initiating computing device is capable of displaying an initiating graphical user interface and the invited computing device is capable of displaying an invited graphical user interface, and the step of causing the suggested settlement amount to be displayed further comprising:
causing the suggested settlement amount and an initiating party settlement option to be displayed within the initiating graphical user interface, the initiating party settlement option permitting entry by the initiating party acceptance or rejection of the suggested settlement amount; and
causing the suggested settlement amount and an invited party settlement option to be displayed within the invited graphical user interface, the invited party settlement option permitting entry by the invited party acceptance or rejection of the suggested settlement amount.

12. The method of claim 11, further comprising the steps of:
receiving an initiating party settlement decision;
receiving an inviting party settlement decision; and
causing a settlement outcome to be displayed on at least one of the initiating computing device and the invited computing device.

13. The method of claim 11, further comprising the step of, when at least one of an initiating party settlement decision and the invited party settlement decision indicates rejection of the suggested settlement amount, causing a failure notification to be displayed on at least one of the initiating computing device and the invited computing device.

14. The method of claim 13, further comprising the step of causing an offer update prompt to be displayed on at least one of the initiating computing device and the invited computing device, the offer update prompt requesting entry of an updated appropriate one of the creditor offer and the debtor offer.

15. The method of claim 14, further comprising the steps of:
communicating a first offer update prompt to the initiating computing device requesting entry of an updated appropriate one of the creditor offer and the debtor offer; and
communicating a second offer update prompt to the invited computing device requesting entry of an updated appropriate one of the creditor offer and the debtor offer.

16. The method of claim 15, further comprising the steps of:
receiving the updated creditor offer;
receiving the updated debtor offer;
determining an updated suggested settlement amount utilizing an updated data set containing at least one of the updated creditor offer and the updated debtor offer; and
causing the updated suggested settlement amount to be displayed on the initiating computing device and the invited computing device.

17. The method of claim 1, further comprising the steps of:
receiving a first case description summary entered on the initiating computing device; and
receiving a second case summary entered on the inviting computing device.

18. The method of claim 17, further comprising the steps of, when the initiating party decision and the invited party decision both indicate an acceptance of the suggested settlement amount:
causing a successful settlement notification to be displayed on the initiating computing device and the invited computing device;
causing a settlement payment prompt to be displayed on one of the initiating computing device and the invited computing device, the settlement payment prompt requesting the payment of a debt amount indicated in the suggested settlement amount;
receiving a debt payment confirmation; and
communicating a settlement document to the initiating computing device and the invited computing device, the settlement document describing settlement terms of the dispute.

19. A method for automatically facilitating a monetary settlement process in connection with a dispute between an initiating party utilizing an initiating computing device and an invited party utilizing an invited computing device, the method comprising the steps of:
implementing an at least one server in selective communication with each of the initiating computing device and invited computing device;
receiving, via the at least one server, a creditor offer representing the minimum value the appropriate one of the initiating party and invited party is willing to accept to resolve the matter;
receiving, via the at least one server, a debtor offer representing the maximum value the appropriate one of the initiating party and invited party is willing to pay to resolve the matter;
receiving, via the at least one server, a matter value from at least one of the initiating computing device and the invited computing device;
comparing, via the at least one server, the creditor offer and the debtor offer to determine a dispute amount difference;
determining, via the at least one server, a settlement percentage;
calculating, via the at least one server, a first potential amount by multiplying the matter value by the settlement percentage;
calculating, via the at least one server, a second potential amount based on the creditor offer and the debtor offer;
upon determining that the debtor offer is less than the creditor offer, setting a second potential amount to be equal to the debtor offer;
upon determining that the debtor offer is greater than or equal to the creditor offer, setting the second potential amount to be equal to the creditor offer;
upon the at least one server determining that the second potential amount is greater than the first potential amount, setting the settlement amount to be equal to the second potential amount;
upon the at least one server determining that the second potential amount is less than or equal to the first potential amount, calculating, via the at least one server, a third potential amount, the third potential amount being equal to the difference between the creditor offer and the debtor offer, multiplied by the settlement percentage, plus the second potential amount;
determining, via the at least one server, a minimum percentage based on at least one of the matter value, the creditor offer and the debtor offer;
determining, via the at least one server, a standard percentage based on at least one of the matter value, the creditor offer and the debtor offer;
upon the at least one server determining that the third potential amount is less than the product of the matter value and the minimum percentage, setting the suggested settlement amount to be equal to the product of the matter value and the standard percentage;
upon the at least one server determining that the third potential amount is greater than or equal to the product of the matter value and the minimum percentage, setting the suggested settlement amount to be equal to the third potential amount; and
causing the suggested settlement amount to be displayed on the initiating computing device and the invited computing device.

20. A system for facilitating a monetary settlement process in connection with a dispute between an initiating party and an invited party, the system comprising:
an initiating computing device under the control of the initiating party;
an invited computing device under the control of the invited party; and
a central computer system in communication with each of the initiating computing device and invited computing device;
wherein, upon the initiating party and invited party desiring to negotiate a monetary settlement of the dispute through the computer system, the computer system is configured for:
receiving, via the at least one server, a creditor offer representing the minimum value the appropriate one of the initiating party and invited party is willing to accept to resolve the matter;
receiving, via the at least one server, a debtor offer representing the maximum value the appropriate one of the initiating party and invited party is willing to pay to resolve the matter;
receiving, via the at least one server, a matter value from at least one of the initiating computing device and the invited computing device;
comparing, via the at least one server, the creditor offer and the debtor offer to determine a dispute amount difference;
determining, via the at least one server, a settlement percentage;
calculating, via the at least one server, a first potential amount by multiplying the matter value by the settlement percentage;
calculating, via the at least one server, a second potential amount based on the creditor offer and the debtor offer;
upon the at least one server determining that the second potential amount is greater than the first potential amount, setting the settlement amount to be equal to the second potential amount;
upon the at least one server determining that the second potential amount is less than or equal to the first potential amount, calculating, via the at least one server, a third potential amount;
determining, via the at least one server, a minimum percentage based on at least one of the matter value, the creditor offer and the debtor offer;
determining, via the at least one server, a standard percentage based on at least one of the matter value, the creditor offer and the debtor offer;
upon the at least one server determining that the third potential amount is less than the product of the matter value and the minimum percentage, setting the suggested settlement amount to be equal to the product of the matter value and the standard percentage;
upon the at least one server determining that the third potential amount is greater than or equal to the product of the matter value and the minimum percentage, setting the suggested settlement amount to be equal to the third potential amount; and
causing the suggested settlement amount to be displayed on the initiating computing device and the invited computing device.
